(19) United States
(12) Patent Application Publication
(10) Pub. No.: US 2025/0084293 A1
(43) Pub. Date: Mar. 13, 2025

(54) COMPOSITIONS AND METHODS FOR APPLYING ABRASIVE HARDFACING MATERIALS

(71) Applicant: AMERMIN LLC, Austin, TX (US)

(72) Inventor: Ryan McAdams, Austin, TX (US)

(21) Appl. No.: 18/882,684

(22) Filed: Sep. 11, 2024

Related U.S. Application Data
(60) Provisional application No. 63/537,711, filed on Sep. 11, 2023.

(51) Int. Cl. C09K 3/14

(52) U.S. Cl. CPC C09K 3/1409; C09K 3/1436

(57) ABSTRACT

In an example, a wire product includes a metallic tubing and an abrasive powder encased by the tubing. The abrasive powder includes a tungsten carbide powder in an amount of 30% to 60% by weight; a metallic binder powder in an amount of 30% to 70% by weight; and a diamond powder in an amount of 0.1% to 2.0% by weight. The diamond powder includes tungsten coated diamonds.

### CROSS-REFERENCE TO RELATED APPLICATION(S)

This application claims benefit of U.S. Provisional Application No. 63/537,711, filed Sep. 11, 2023, which is incorporated herein by reference in its entirety.

### BACKGROUND

A variety of mechanical operations utilize abrasive surfaces remove material from opposing surfaces. One such operation is drilling into rock or stone, for example, to form wellbores.

Wellbores can be drilled into subterranean formations for purposes like oil, gas, and geothermal heat extraction. They are formed using earth-boring rotary drill bits, such as fixed-cutter, roller cone, diamond-impregnated, and hybrid bits. The drill bit, under weight-on-bit (WOB) force, rotates and cuts into the formation to create the wellbore.

Earth-boring tools must be hard and wear-resistant to efficiently drill without wearing out. However, harder materials are typically brittle, while materials with high fracture toughness are softer. So, there is a need to balance hardness and toughness. To achieve this, composite materials, called “hardfacing,” are applied to drill bits.

Hardfacing materials can be applied using various methods, including automated and manual welding. In manual processes, a welding rod with the hardfacing material is melted and applied to the tool. Some rods are solid, while others are tubular, containing hard particles. Flame spray processes and arc welding methods, such as Metal Inert Gas (MIG) welding, Tungsten Inert Gas (TIG) welding, and Plasma Transferred Arc (PTA) welding, are also used to apply hardfacing materials.

There is a continued demand for more abrasive and wear-resistant hardfacing materials with enhanced resistance to abrasion and erosion.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an example welding wire.

FIG. 2 includes a block flow diagram of an example method for forming a welding wire.

FIG. 3 includes an illustration of an example welding rod.

FIG. 4 includes a block flow diagram of an example method for forming a welding rod.

The use of the same reference symbols in different drawings indicates similar or identical items.

### DETAILED DESCRIPTION

In an embodiment, a product for applying a hardfacing material includes a metallic binder, tungsten carbide, and a diamond powder. The diamond powder includes titanium coated diamonds. In an example, the titanium coated diamonds include a monocrystalline diamond core. The product can be in the form of a welding wire, a welding rod, or a coating powder. The product can be applied using arc welding, such as MIG or TIG welding, plasma welding, or flame spray coating. In particular, the product has a desirable deposition integrity performance in which a sufficient amount of the diamond particulate remains following deposition despite high temperatures.

The product includes an abrasive material. The abrasive material can be in the form of an abrasive powder, such as a sintered abrasive powder. In an example, the abrasive powder includes a metallic binder in the amount of 30% to 70% by weight, a tungsten carbide powder in an amount of 30% to 60% by weight, and a diamond powder in an amount of 0.1% to 2% by weight. The diamond pattern includes tungsten coated diamonds.

The metallic binder powder can include nickel and can also include other components such as boron, iron, chromium, silicon, or carbon. In an example, the metallic binder includes nickel, chromium, silicon, and optionally other components. The metallic binding powder can include, for example, boron in an amount of 0.0% to 5.0%, such as 1.0% to 3.0%. In another example, the metallic binding powder can include iron in an amount of 0.0% to 4.0%, such as 2.0% to 3.2%. In a further example, the metallic binding powder can include chromium in a range of 5.0% to 15.0%, such as 6.0% to 12.0%. In an additional example, the metallic binding powder can include silicon in an amount of 0.0% to 5.0%, such as 2.0% to 4.0%. In another example, the metallic binding powder can include carbon in an amount of 0.0% to 1.0%, such as 0.1% to 0.5%.

The tungsten carbide powder can have a size range in a range of 40 μm to 250 μm, such as a range of 40 μm to 220 μm. The tungsten carbide powder can be a spherical cast powder. In another example, the tungsten carbide powder can be an angular cast powder. In a further example, the tungsten carbide powder is a blend of spherical cast powder and angular cast powder. For example, tungsten carbide blend can include the spherical cast powder in a range of 50% to 90% of the tungsten carbide powder such as 65% to 80% of the tungsten carbide. In a further example, the tungsten carbide blend can include the angular cast powder in a range of 10% to 45%, such as a range of 18% to 35% of the tungsten carbide blend.

In an example, the diamonds of the diamond particulate are monocrystalline. The monocrystalline diamond particulate can be formed using artificial methods. For example, the monocrystalline diamond particles can be formed using chemical vapor deposition (CVD) with a carbon plasma over a substrate onto which the carbon atoms deposit to form diamond. In an example, the carbon plasma is derived from a carbon source and hydrogen.

In a further example, the diamond particulate is coated with tungsten. The tungsten coating can be applied using chemical vapor deposition techniques. In an additional example, the diamond particulate is coated with titanium carbide. For example, the titanium carbide coating can be applied using chemical vapor deposition techniques. In one example, the titanium carbide coating is applied directly to a diamond core, and a tungsten coating is applied over the titanium carbide coating. Alternatively, the titanium carbide can be deposited over a tungsten coated diamond.

The tungsten coating can have a thickness in a range of 1 nm to 900 nm. For example, the tungsten coating can have a thickness in a range of 10 nm to 900 nm, such as a range of 100 nm to 800 nm or a range of 250 nm to 750 nm.

The titanium carbide coating can have a thickness in a range of 1 nm to 900 nm. For example, the titanium carbide coating can have a thickness in a range of 10 nm to 900 nm, such as a range of 100 nm to 900 nm or a range of 250 nm to 800 nm.

The tungsten coated diamonds can have a size in a range of 50 μm to 300 μm, such as a range of 60 μm to 297 μm or a range of 70 μm to 255 μm.

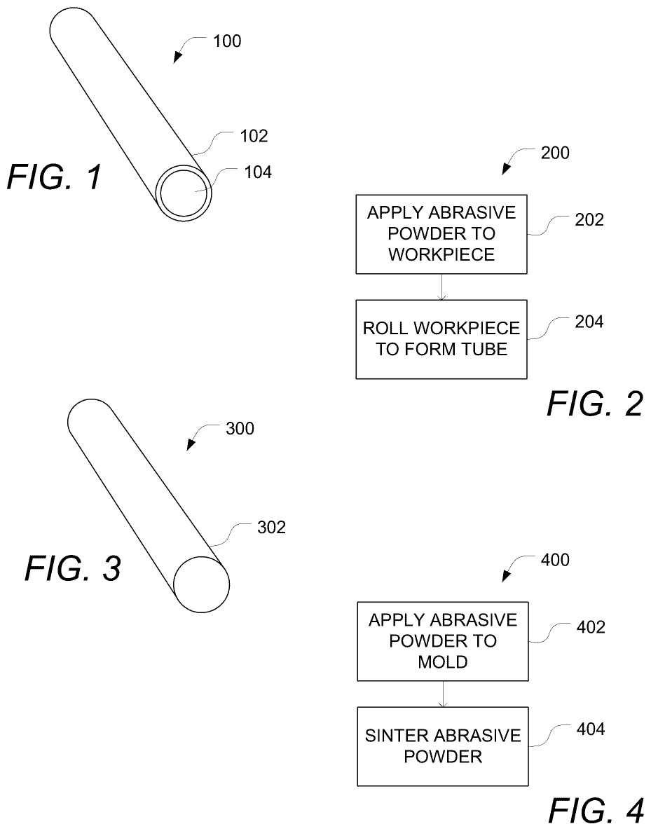

In an example, the product to form the hardfacing material is in the form of a wire product, such as wire product 100 illustrated in FIG. 1. The wire product 100 can include a metallic tubing 102 and an abrasive powder 104 encased by the tubing 102. The abrasive powder 104 can include a tungsten carbide powder, a metallic binding powder, and a diamond powder. The diamond powder can be a tungsten coated diamond powder. In an example, the metallic tubing includes nickel or a nickel alloy.

In an example, the tungsten carbide powder is included in the abrasive powder in an amount of 30% to 60% by weight. For example, the tungsten carbide powder can be included in an amount of 35% to 55%, such as 47% to 52%. The tungsten carbide powder can have a size in a range of 40 μm to 250 μm. For example, the size of the tungsten carbide powder can be in a range of 70 μm to 215 μm, such as a range of 70 μm to 180 μm.

In an example, the metallic binder powder is included in an amount of 30% to 70% by weight, such as an amount of 35% to 60%, an amount of 40% to 55%, or an amount of 45% to 53%. The metallic binder powder can include a nickel base and other components, such as those described above. In particular, the metallic binder powder can include nickel and components selected from boron, iron, chromium, silicon, or carbon. In an example, the metallic binder powder includes nickel, chromium, silicon, and optionally other components.

In an example, the diamond powder can be included in an amount of 0.1% to 2.0%, such as an amount of 0.2% to 1.5% or an amount of 0.2% to 0.9% by weight. The tungsten coated diamonds can be further coated in titanium carbide. In an example, the tungsten coating of the tungsten coated diamonds is disposed over the titanium carbide coating. Alternatively, the titanium carbide coating can be disposed over the tungsten coating, which is directly on the diamond core.

The tungsten coated diamonds can have an average size in the range of 149 μm to 297 μm, such as an average size in a range of 175 μm to 255 μm. The tungsten coated diamonds can have a diamond core that is monocrystalline.

The wire products can have a deposition integrity performance of at least 2800° C. For example, the wire product can have a deposition integrity performance of at least 3500° C., such as at least 4500° C. or at least 5500° C. In an example, the deposition integrity performance of the work product is not greater than 20,500° C. The deposition integrity performance is the temperature at which at least 85% of the diamond material within the product remains intact during the deposition process or application of the hardfacing material when using an arc welding technique. In other words, the applied hardfacing material includes at least 85% of the diamond material of the product. For example, the hardfacing material includes at least 85% of the diamond material of the abrasive powder in the wire following deposition by MIG, TIG, or PTA welding.

The wire product can be formed by rolling tubing around the abrasive material. For example, as illustrated in FIG. 2, an abrasive powder can be applied to a workpiece, as illustrated at block 202. In an example, the workpiece is in the form of an elongated metal component including a central channel into which the abrasive powder is deposited. The workpiece is then rolled around the abrasive powder, as illustrated in block 204, forming a tubing encasing the abrasive powder.

In another example, the product is in the form of a powder that can be flame sprayed to form a hardfacing material. In an example, the coating powder includes a metallic binder, tungsten carbide, and a diamond powder. The diamond powder can include tungsten coated diamonds.

The metallic binder powder can be included in an amount of 30% to 70% by weight, such as an amount of 35% to 60%, an amount of 40% to 55% by weight, or an amount of 40% to 53% by weight. The metallic binder can include nickel. In addition, the metallic binder powder can include boron, iron, chromium, silicon, or carbon. For example, the metallic binder powder includes nickel, chromium, silicon, and optionally other components.

The tungsten carbide powder can be included in the coating powder in an amount of 30% to 60% by weight. For example, the titanium carbide powder can be included in an amount of 40% to 60%, such as an amount of 47% to 57%.

The tungsten carbide powder can have a size in a range of 40 μm to 250 μm. In an example, the tungsten carbide powder includes a spherical cast powder. In another example, the tungsten carbide powder includes an angular cast powder. In a further example, the tungsten carbide power can include a blend of spherical cast powder and angular cast powder. Spherical cast powder can have a size in a range of 50 μm to 150 μm, such as a range of 50 μm to 130 μm. The angular cast powder can have a size in the range of 40 μm to 100 μm, such as a range of 40 μm to 90 μm. The tungsten carbide blend can include the spherical cast powder in an amount of 50% to 90% by weight of the tungsten carbide powder, such as 65% to 80% of the tungsten carbide powder. The tungsten carbide blend can also include the angular cast powder in an amount of 10% to 45%, such as 18% to 35% of the tungsten carbide powder.

In an example, the diamond powder is included in an amount of 0.1% to 2.0%. For example, the diamond powder can be included in an amount of 0.2% to 1.5%, such as an amount of 0.2% to 0.9% by weight. The tungsten coated diamonds can include a monocrystalline diamond core coated with tungsten. The tungsten coated diamonds can further include a titanium carbide coating. The tungsten coated diamonds can have a size in a range of 60 μm to 210 μm, such as a size in a range of 70 μm to 80 μm.

The coating powder can have deposition integrity performance of at least 2800° C. For example, coating powder can have a deposition integrity performance of at least 3500° C., such as 4500° C. or even 5500° C. In an example, the coating powder has an integrity performance of not greater than 20,500° C.

In an example, the hardfacing material can be formed by flame spray coating the coating powder onto the surface. Flame spray coating is used to deposit hardfacing materials onto a substrate to provide wear resistance and corrosion resistance. The process begins by preparing the surface of the substrate. This involves cleaning it to remove any contaminants and optionally roughening it (typically by grit blasting) to ensure a strong bond between the coating and the substrate. The coating material (wire or powder) is continuously fed into the flame spray gun. In the case of powder feedstock, the powder is fed into the flame where it gets melted. A combustible gas, often acetylene, propane, or hydrogen, is mixed with oxygen to produce a flame in the spray gun. This flame is used to melt the coating material. As the coating material melts, it is propelled towards the substrate using compressed air. The molten droplets of the coating material flatten when they hit the substrate, solidifying rapidly to form a layered coating. The sprayed droplets cool and solidify upon contact with the substrate, forming a bond. The accumulation of droplets results in the formation of a continuous coating that adheres to the substrate surface. Once the spraying process is complete, the coated surface might undergo further processes, such as grinding, polishing, or heat treatment, to achieve the desired finish and properties.

In an additional example, the hardfacing material can be formed of an abrasive welding rod 300 illustrated in FIG. 3. The abrasive welding rod can include a metallic binder 302, a tungsten carbide powder, and a diamond powder. The diamond powder can include tungsten coated diamonds.

The metallic binding powder can be included in an amount of 30% to 70%. For example, the metallic binder can be included in amount of 35% to 60%, such as an amount of 40% to 55% or an amount of 45% to 53%. The metallic binder can include nickel. In addition, the metallic binder can include components selected from boron, iron, chromium, silicon, or carbon. In an example, the metallic binder includes nickel, chromium, silicon, and optionally other components.

The tungsten carbide powder can be included in an amount of 30% to 60% by weight. For example, the tungsten carbide powder can be included in an amount of 35% to 55%, such as an amount of 47% to 52%. The tungsten carbide powder can have a size in a range of 40 μm to 250 μm, such as a range of 70 μm to 250 μm or a range of 70 μm to 180 μm.

The tungsten coated diamonds can have a diamond core that is monocrystalline. In addition, the tungsten coating of the tungsten coated diamonds can be disposed over a titanium carbide coating disposed on the surface of the diamonds. Alternatively, a titanium carbide coating can be disposed over a tungsten coating in contact with the diamond core.

In an example, the powder is included in an amount of 0.1% to 2.0% such as an amount of 0.2% to 1.5% or an amount of 0.2% 0.9%. The tungsten coated diamonds can have an average size in a range of 149 μm to 297 μm, such as a size in a range of 175 μm to 255 μm. The abrasive welding rod can have a deposition integrity performance of at least 2800° C. For example, the abrasive welding rod can have a deposition integrity performance of at least 3500° C., such as at least 4500° C. or even 5500° C. The abrasive welding rods can have a deposition integrity performance that is not greater than 20,500° C.

As illustrated in FIG. 4, the welding rod can be formed by applying a component powder including the ingredients described above into a mold, as illustrated at block 402. The molded powder can then be sintered, as illustrated at block 404. In an example, the powder can be sintered at a temperature in a range of 1300° C. to 2700° C.

Particular embodiments of the above-described materials useful in forming hardfacing material coatings exhibit advantages performance. In an example, the described materials can be applied using high temperature application processes, such as arc welding and flame spraying without a degradation of the abrasive materials including the type diamonds. Hardfacings formed by such materials exhibit exceptional abrasive qualities and are slow to degrade or wear.

### Example

Example abrasive wire is welded to a metal surface using gas metal arc welding (MIG). Welding is performed direct current reverse polarity (DCRP) at 23 volts and 175 amps with a 150 inch per minute speed using a gas composition 90% Ar/10% CO₂.

Following welding, the welded surface is subjected to grinding using a 60 grit J hardness aluminum oxide grinding wheel with an 8 inch diameter and 1 inch thickness. Little wear is found on the sample, with only mild polishing of the surface noted.

As used herein, compositions expressed in percentages are weight percentages. Average size refers to the median size of the population of particles.

In a first aspect a wire product includes a metallic tubing and an abrasive powder encased by the tubing. The abrasive powder includes tungsten carbide powder in an amount of 30% to 60% by weight, a metallic binder powder in an amount of 30% to 70% by weight, and diamond powder in an amount of 0.1% to 2.0% by weight. The diamond powder includes tungsten-coated diamonds.

In an example of the first aspect, the metallic tubing includes nickel.

In another example of the first aspect and the above examples, the tungsten carbide powder is included in an amount of 35% to 55% by weight. In a more specific example, the tungsten carbide powder is included in the amount of 47% to 52% by weight. The tungsten carbide powder may have a size in a range of 40 microns to 250 microns, and in further examples, the size may be in a range of 70 microns to 215 microns, or even more specifically, in the range of 70 microns to 180 microns.

In a further example of the first aspect and the above examples, the metallic binder powder may be included in an amount of 35% to 60% by weight, or in a more specific example, 40% to 55% by weight. In another example, the metallic binder powder is included in an amount of 45% to 53% by weight. The metallic binder powder may include nickel and other components selected from the group consisting of boron, iron, chromium, silicon, or carbon. In a further example, the metallic binder powder includes nickel, chromium, and silicon.

In an additional example of the first aspect and the above examples, the tungsten-coated diamonds may be further coated with titanium carbide, where a tungsten coating is disposed over the titanium carbide coating.

In another example of the first aspect and the above examples, the diamond powder may be included in an amount of 0.2% to 1.5%, and in a more specific embodiment, 0.2% to 0.9%.

In a further example of the first aspect and the above examples, the tungsten-coated diamonds may have an average size in the range of 149 microns to 297 microns. In a further embodiment, the average size is in the range of 175 microns to 255 microns.

In an additional example of the first aspect and the above examples, the tungsten-coated diamonds may have a monocrystalline diamond core.

In another example of the first aspect and the above examples, the tungsten-coated diamonds may exhibit a Deposition Integrity Performance of at least 3500° C., 4500° C., or even 5500° C. In one example, the Deposition Integrity Performance is not greater than 20,500° C.

In a second aspect a coating powder for flame spraying includes a tungsten carbide powder in an amount of 30% to 60% by weight, a metallic binder powder in an amount of 30% to 70% by weight, and a diamond powder in an amount of 0.1% to 2.0% by weight, with the diamond powder including tungsten-coated diamonds.

In one example of the second aspect, the tungsten carbide powder is included in an amount of 45% to 60% by weight, and in a more refined example, 47% to 57% by weight.

In another example of the second aspect and the above examples, the tungsten carbide powder may have a size in a range of 40 microns to 150 microns. The tungsten carbide powder may also include a spherical cast powder, comprising 50% to 90% of the tungsten carbide powder, or in another example, 65% to 80%. The spherical cast powder may have a size in the range of 50 microns to 150 microns, or more specifically, 50 microns to 130 microns.

In an additional example of the second aspect and the above examples, the tungsten carbide powder may also include an angular cast powder, comprising 10% to 45% of the tungsten carbide powder. In a more specific example, it comprises 18% to 35% of the powder and may have a size in the range of 40 microns to 100 microns, or more particularly, 40 microns to 90 microns.

In a further example of the second aspect and the above examples, the metallic binder powder may be included in an amount of 35% to 60% by weight, or in a more specific example, 40% to 55% by weight. In another example, it is included in an amount of 45% to 53%.

In an additional example of the second aspect and the above examples, the metallic binder powder may include nickel and other components selected from the group consisting of boron, iron, chromium, silicon, or carbon. In a further embodiment, the binder powder includes nickel, chromium, and silicon.

In another example of the second aspect and the above examples, the tungsten-coated diamonds may be further coated with titanium carbide, where the tungsten coating is disposed over the titanium carbide.

In a further example of the second aspect and the above examples, the diamond powder may be included in an amount of 0.2% to 1.5%, or in a more specific embodiment, 0.2% to 0.9%.

In an additional example of the second aspect and the above examples, the tungsten-coated diamonds may have an average size in the range of 60 microns to 210 microns, or more particularly, 70 microns to 180 microns. The tungsten-coated diamonds may have a monocrystalline diamond core.

In another example of the second aspect and the above examples, the tungsten-coated diamonds may exhibit a Deposition Integrity Performance of at least 3500° C., 4500° C., or even 5500° C. In another example, the Deposition Integrity Performance is not greater than 20,500° C.

In a third aspect an abrasive welding rod includes a tungsten carbide powder in an amount of 30% to 60% by weight, a metallic binder powder in an amount of 30% to 70% by weight, and a diamond powder in an amount of 0.1% to 2.0% by weight, where the diamond powder includes tungsten-coated diamonds.

In an example of the third aspect, the tungsten carbide powder is included in an amount of 35% to 55% by weight, and in a more refined example, 47% to 52% by weight.

In another example of the third aspect and the above examples, the tungsten carbide powder may have a size in a range of 40 microns to 250 microns, or in further examples, a size in the range of 70 microns to 215 microns, or even more particularly, 70 microns to 180 microns.

In a further example of the third aspect and the above examples, the metallic binder powder may be included in an amount of 35% to 60% by weight, or more specifically, 40% to 55%. In another example, it is included in an amount of 45% to 53%.

In an additional example of the third aspect and the above examples, the metallic binder powder may include nickel and components selected from the group consisting of boron, iron, chromium, silicon, or carbon. In a further example, the metallic binder includes nickel, chromium, and silicon.

In another example of the third aspect and the above examples, the tungsten-coated diamonds may be further coated with titanium carbide, where the tungsten coating is disposed over the titanium carbide coating.

In a further example of the third aspect and the above examples, the diamond powder may be included in an amount of 0.2% to 1.5%, or in a more specific embodiment, 0.2% to 0.9%.

In an additional example of the third aspect and the above examples, the tungsten-coated diamonds may have an average size in the range of 149 microns to 297 microns, or in a further example, in the range of 175 microns to 255 microns. The tungsten-coated diamonds may have a monocrystalline diamond core.

In another example of the third aspect and the above examples, the tungsten-coated diamonds may exhibit a Deposition Integrity Performance of at least 3500° C., 4500° C., or even 5500° C. In one example, the Deposition Integrity Performance is not greater than 20,500° C.

In a fourth aspect a method for forming a wire product includes applying an abrasive powder to a metallic workpiece, where the abrasive powder includes tungsten carbide powder in an amount of 30% to 60% by weight, a metallic binder powder in an amount of 30% to 70% by weight, and diamond powder in an amount of 0.1% to 2.0% by weight. The diamond powder includes tungsten-coated diamonds. The method further comprises rolling the metallic workpiece to form a tube surrounding the abrasive powder.

In an example of the fourth aspect, the metallic workpiece includes nickel.

In another example of the fourth aspect and the above examples, the tungsten carbide powder is included in an amount of 35% to 55% by weight. In a more specific example, the tungsten carbide powder is included in the amount of 47% to 52% by weight.

In a further example of the fourth aspect and the above examples, the tungsten carbide powder may have a size in a range of 40 microns to 250 microns, and in a further example, the size is in the range of 70 microns to 215 microns, or even more specifically, 70 microns to 180 microns.

In an additional example of the fourth aspect and the above examples, the metallic binder powder may be included in an amount of 35% to 60% by weight, or in a more specific example, 40% to 55% by weight. In another example, it is included in an amount of 45% to 53%.

In another example of the fourth aspect and the above examples, the metallic binder powder may include nickel and other components selected from the group consisting of boron, iron, chromium, silicon, or carbon. In a further embodiment, the metallic binder powder includes nickel, chromium, and silicon.

In a further example of the fourth aspect and the above examples, the tungsten-coated diamonds may be further coated with titanium carbide, where a tungsten coating is disposed over the titanium carbide coating.

In an additional example of the fourth aspect and the above examples, the diamond powder may be included in an amount of 0.2% to 1.5%, or in a more specific example, 0.2% to 0.9%.

In another example of the fourth aspect and the above examples, the tungsten-coated diamonds may have an average size in the range of 149 microns to 297 microns, or more specifically, 175 microns to 255 microns.

In a further example of the fourth aspect and the above examples, the tungsten-coated diamonds may have a monocrystalline diamond core.

In an additional example of the fourth aspect and the above examples, the tungsten-coated diamonds may exhibit a Deposition Integrity Performance of at least 3500° C., 4500° C., or even 5500° C. In another example, the Deposition Integrity Performance is not greater than 20,500° C.

In a fifth aspect a method for forming an abrasive welding rod includes applying an abrasive powder to a mold, where the abrasive powder includes tungsten carbide powder in an amount of 30% to 60% by weight, a metallic binder powder in an amount of 30% to 70% by weight, and diamond powder in an amount of 0.1% to 2.0% by weight. The diamond powder includes tungsten-coated diamonds. The method further comprises sintering the abrasive powder to form the abrasive welding rod.

In an example of the fifth aspect, the tungsten carbide powder is included in an amount of 35% to 55% by weight. In a more refined example, the tungsten carbide powder is included in the amount of 47% to 52%.

In another example of the fifth aspect and the above examples, the tungsten carbide powder may have a size in a range of 40 microns to 250 microns, or in further examples, a size in the range of 70 microns to 215 microns, or more specifically, 70 microns to 180 microns.

In a further example of the fifth aspect and the above examples, the metallic binder powder may be included in an amount of 35% to 60% by weight, or in a more specific embodiment, 40% to 55%. In another example, the metallic binder powder is included in an amount of 45% to 53%.

In an additional example of the fifth aspect and the above examples, the metallic binder powder may include nickel and other components selected from the group consisting of boron, iron, chromium, silicon, or carbon. In a further embodiment, the binder powder includes nickel, chromium, and silicon.

In another example of the fifth aspect and the above examples, the tungsten-coated diamonds may be further coated with titanium carbide, where a tungsten coating is disposed over the titanium carbide.

In a further example of the fifth aspect and the above examples, the diamond powder may be included in an amount of 0.2% to 1.5%, or in a more specific example, 0.2% to 0.9%.

In an additional example of the fifth aspect and the above examples, the tungsten-coated diamonds may have an average size in the range of 149 microns to 297 microns, or more specifically, 175 microns to 255 microns.

In another example of the fifth aspect and the above examples, the tungsten-coated diamonds may have a monocrystalline diamond core.

In a further example of the fifth aspect and the above examples, the tungsten-coated diamonds may exhibit a Deposition Integrity Performance of at least 3500° C., 4500° C., or even 5500° C. In another example, the Deposition Integrity Performance is not greater than 20,500° C.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A wire product comprising:
a metallic tubing; and
an abrasive powder encased by the tubing, the abrasive powder including:
a tungsten carbide powder in an amount of 30% to 60% by weight;
a metallic binder powder in an amount of 30% to 70% by weight; and
a diamond powder in an amount of 0.1% to 2.0% by weight, the diamond powder including tungsten coated diamonds.

2. The wire product of claim 1, wherein the metallic tubing includes nickel.

3. The wire product of claim 1, wherein the tungsten carbide powder is included in an amount of 35% to 55% by weight.

4. The wire product of claim 3, wherein the tungsten carbide powder is included in the amount of 47% to 52% by weight.

5. The wire product of claim 1, wherein the tungsten carbide powder has a size in a range of 40 microns to 250 microns.

6. The wire product of claim 5, wherein the size is in a range of 70 microns to 215 microns.

7. The wire product of claim 6, wherein the size is in a range of 70 microns to 180 microns.

8. The wire product of claim 1, the metallic binder powder is included in an amount of 35% to 60% by weight.

9. The wire product of claim 8, wherein the metallic binder powder is included in an amount of 40% to 55% by weight.

10. The wire product of claim 9, wherein the metallic binder powder is included in an amount of 45% to 53% by weight.

11. The wire product of claim 1, wherein the metallic binder powder includes nickel and includes components selected from the group consisting of boron, iron, chromium, silicon, or carbon.

12. The wire product of claim 11, wherein the metallic binder powder includes nickel, chromium, and silicon.

13. The wire product of claim 1, wherein the tungsten coated diamonds are further coated in titanium carbide.

14. The wire product of claim 13, wherein a tungsten coating of the tungsten coated diamonds is disposed over a titanium carbide coating.

15. The wire product of claim 1, wherein the diamond powder is included in an amount of 0.2% to 1.5%.

16. The wire product of claim 16, wherein the diamond powder in an amount of 0.2% to 0.9%.

17. The wire product of claim 1, wherein the tungsten coated diamonds have an average size in the range of 149 microns to 297 microns.

18. The wire product of claim 17, wherein the tungsten coated diamonds have an average size in the range of 175 microns to 255 microns.

19. The wire product of claim 1, wherein the tungsten coated diamonds have a monocrystalline diamond core.

20. The wire product of claim 1, wherein the tungsten coated diamonds have a Deposition Integrity Performance of at least 3500° C.

21.-120. (canceled)
